(19) United States
(12) Patent Application Publication
(10) Pub. No.: US 2024/0401831 A1
(43) Pub. Date: Dec. 5, 2024

(54) VENTILATION DEMAND CONTROL

(71) Applicant: TAMWORTH CORPORATION LIMITED, Essex (GB)

(72) Inventors: Alexander James Fletcher LLOYD, Essex (GB); James Charles Edward LLOYD, Essex (GB)

(21) Appl. No.: 18/694,638

(22) PCT Filed: Sep. 28, 2022
(86) PCT No.: PCT/EP2022/077030

§ 371 Date: Mar. 22, 2024

(30) Foreign Application Priority Data
Sep. 29, 2021 (GB) 2113967.0

(51) Int. Cl. F24F 11/63; F24F 11/74; F24F 11/76; F24F 11/77

(52) U.S. Cl. CPC F24F 11/63; F24F 11/74; F24F 11/76; F24F 11/77

(57) ABSTRACT

A computer-implemented method of controlling ventilation in a closed space (240, 310) and related system. The method comprises receiving. at a controller (275) comprising a processor (560)), from at least one sensor consisting of a temperature sensor (360, 370), input relating to temperature from the temperature sensor (360, 370) (step 100): calculating. using a processor (560), the desired speed of at least one extractor fan (270) based upon the input from the temperature sensor (step 110): transmitting from the controller to the extractor fan (270) a signal to power the at least one extractor fan (270) to the desired speed (step 120); calculating. using the processor (560), the desired intake of air from at least one air intake (285) based upon the speed of the at least one extractor fan (step 130); transmitting from the controller (275) to the air intake (285) a signal to operate the at least one air intake for the desired intake of air (step 140)).

This invention is a computer implemented method of controlling ventilation in a closed space and a ventilation demand control system.

Ventilation demand control systems optimise ventilation in a closed space such as a building. Ventilation is controlled so that energy can be saved and that an appropriate level of ventilation is provided. In certain environments, such as a kitchen, ventilation is important to ensure that the temperature and atmosphere is properly controlled. In a kitchen, particularly a commercial kitchen where several cooking appliances are operating at once, the temperature can quickly rise to levels that are unsafe to work in and smoke, steam and vaporized particles from cooking will negatively affect air quality.

Therefore, kitchens, and in particular commercial kitchens, will be provided with extractor fans to extract air from inside the closed space, and may further be provided with an intake fan to replace the extracted air with clean air. Generally, one extractor fan will be provided for at least one cooking appliance and be provided with an extraction hood to contain and extract air that rises from the or each cooking appliance.

The rate at which air is extracted and replaced may be controlled with a ventilation demand control system which receives input from a number of sensors to monitor the air within the enclosed space and control the extraction and/or intake of air accordingly. The ventilation may be controlled automatically, manually, or both. As the temperature within the closed space increases, or the air quality diminishes, the extraction rate may be increased in accordance. As such, the ventilation rate will match the ventilation requirement, and therefore be more energy efficient than if the ventilation system was run at capacity the entire time.

Prior art automated systems rely on a number of different sensors to detect the conditions within the closed space. These include optical sensors, CO2 sensors and gas meters. Optical sensors will usually be disposed within an extraction hood placed above one or more cooking appliance. These optical sensors detect the amount of smoke or steam emanating from the or each cooking appliance as a proxy for the or each cooking appliance being in operation, and to monitor the quality of the air. When smoke or steam is sensed, the sensor will cause the extractor fan to switch on.

There are many problems associated with prior art ventilation demand control systems, for example the optical sensors are prone to failure as they get damaged by vaporized oils. Prior art systems are poor at controlling the ventilation within the closed space and particularly systems which can be manually controlled will not be the most efficient in use, as there is a tendency to run the system at too high a rate throughout the day.

It is important that ventilation is controlled appropriately to ensure a safe working environment and to ensure optimal power use which will provide cost and environmental savings.

Therefore, according to the present invention there is provided a computer-implemented method of controlling ventilation in a closed space, the method comprising:
receiving, at a controller, from at least one sensor consisting of a temperature sensor, input relating to temperature from the temperature sensor;
calculating, using a processor, the desired speed of at least one extractor fan based upon the input from the temperature sensor;
transmitting from the controller to the extractor fan a signal to power the at least one extractor fan to the desired speed; and
calculating, using the processor, the desired intake of air from at least one air intake based upon the speed of the at least one extractor fan; and
transmitting from the controller to the air intake a signal to operate the air intake for the desired intake of air.

The present invention is well suited to closed spaces such as commercial kitchens where the environment is constantly changing due to the use of cooking appliances and throughout a day there will be high incidence of temperature variation and changes in air quality unless well ventilated. Therefore, reference will generally be made to kitchens although the present invention is not to be limited in such a way. The present invention could also be used in other similar closed spaces where the environment is subject to change, such as factories that operate heavy machinery which emanate heat and produce airborne particles, or laboratories where a consistent air temperature and quality is required.

According to the present invention, the only sensors used will be one or more temperature sensor to provide an indication of air temperature. The temperature sensor may be disposed in an extraction hood surrounding an extraction fan above one or more cooking appliance, where it can detect the temperature as a result of the use of the cooking appliance. According to the present method, an increase in temperature would be detected by the or each temperature sensor and the processor will transmit a signal to the extractor fan to increase in speed to offset the increase in temperature.

Similarly, if the temperature were to be reduced then the extractor fan will be operated to slow down. This will ensure that the extractor fan does not run at full speed for the duration of its use and thus waste energy. The extractor fan may be run at a minimum speed so that the moving parts of the extractor fan do not suffer unnecessary wear and tear which may result from running at excessively low speeds. Minimum and maximum control speeds can be programmed into a memory associated with the processor, and the fan speeds can be modulated at any rate between the maximum and minimum fan speeds based upon input from the or each temperature sensor.

At least one air intake is provided to introduce fresh air into the closed space to replace extracted air. The air intake may be one or both of a fan or louvre with adjustable slats, which can be operated to control the ingress of fresh air into the closed space. If the air intake is a fan, the speed of the fan may be a set ratio of the speed of the at least one extractor fan.

Preferably, air pressure within the closed space will be controlled by the at least one extractor fan and the air intake. If the air intake is a fan, the fan speed may be set at any speed within the range of 10-90% of the speed of the at least one extractor fan. Therefore, if the extractor fan increases or decreases in speed, the processor will control the intake fan speed to increase and decrease in accordance with the extractor fan speed but at a rate that is proportionally less than the extractor fan speed. If the air intake is a louvre, then the angle of the slats can be adjusted in proportion to the speed of the at least one extractor fan. In order to reduce wear and tear on the louvre as the slats change angle, the slats may be adjustable between two or more pre-set positions. For example, the slats could be moveable between low, medium and high positions which each correspond to pre-set ranges of extractor fan speeds. For example, the slats may be adjusted to a “low” position when the at least one extractor fan speed is operated at 0-3V by the processor, at a “medium” position when the at least one extractor fan speed is operated at 4-7V by the processor and set to a “high” position when the at least one extractor fan speed is operated at 8-10V by the processor.

Therefore, the offset between the extractor fans and the air intake means that the closed space can be kept at a negative pressure. This is advantageous if, for example, the closed space is a kitchen, where it will be desirable to keep the air within the closed space from escaping into surrounding areas. In particular, cooking smells will be retained within the kitchen.

If more than one extractor fan is provided, the desired rate of air intake may be calculated by the processor from an average of the combined extractor fan speeds. Furthermore, if a plurality of extractor fans is provided, generally with one extractor fan per cooking area, only a single air intake may be provided.

Therefore, the air intake may be more powerful than a single extractor fan however the combined extraction from all of the extractor fans may be more than the intake of air from the air intake, so as to maintain a negative pressure.

If there is a plurality of cooking areas, each cooking area may be provided with a temperature sensor as well as an extractor fan. Each cooking area may be controlled individually by the controller. A plurality of extractor fans within the closed space may operate at different speeds to one another depending on the input received by the controller from each sensor. Each extractor fan speed may therefore be independently controllable by the processor. The processor may be able to calculate a desired rate of air intake based on an aggregate of speeds of a plurality of extractor fans.

A further temperature sensor, in addition to any temperature sensors disposed within the extractor hoods, may be located spaced apart from the cooking area or areas so as to measure ambient temperature in the closed space. The present method may further comprise the steps of receiving, at the controller, input relating to temperature from the temperature sensor in the extraction hood and the temperature sensor spaced apart from the cooking area; calculating, using the processor, a temperature difference between the ambient temperature and temperature detected by the sensor in the extraction hood, and, if the temperature difference is above a set threshold, transmitting from the controller to the extractor fan a signal to power the at least one extractor fan to the desired speed.

Therefore, if temperature sensors are provided spaced apart from the extractor hood to detect ambient temperature, a detected difference in temperature could be sufficient to activate the controller and switch on the extractor fan. This could be an advantageous fail safe to switch on the extractor fan should a cooking appliance be activated but before the controller is switched on.

Further, the processor may be able to calculate a rate of change of temperature from the or each temperature sensor which could be indicative of a cooking appliance being turned on. Therefore, the present method may provide the following further steps of: receiving, at the controller, input relating to temperature from the at least one temperature sensor over time; calculating, using the processor, a rate of change of temperature, and, if the rate of change of temperature is above a set threshold, transmitting from the controller to the extractor fan a signal to power the at least one extractor fan to the desired speed. The rate of change could be measured over any period of time, for example any time between 1-14 minutes. The threshold could be measured in number of degrees Celsius or Fahrenheit rising over a minute.

The speed of the one or more extractor fan and/or rate of air intake may be adjusted in real time based on the changes in temperature monitored by the or each temperature sensor. However, constant changing of fan speeds and/or louvre slat position may induce undue wear and tear. Therefore, changes in extractor fan speed and louvre slat position may the effected after a set period of time, for example any period of time between 5 and 120 seconds, between 20and 60 seconds, and for example every 30 seconds, based upon average temperature readings over that time period. Therefore, the present method may comprise the further steps of receiving at the controller, from the or each temperature sensor, input relating to temperature over a set period of time;

calculating, at the processor, an average desired speed of each extractor fan and/or air inlet, over the set period of time; wherein the controller transmits to the extractor fan and/or air intake the desired speed after the set period of time. Thus, the speed of the extractor fan and/or rate of air intake will only be changed after a set period of time based on average temperatures, and therefore reduce wear and tear.

The controller may be constantly on, for example if used in a 24-hour kitchen, and the extractor fans and air inlet will run at the lowest pre-set speeds when the kitchen is not in use, and there will be option to manually switch off the controller. Alternatively, the controller may be provided with a timer or calendar function so that it switches on and off automatically at a pre-set time. The pre-set time could be programmed on a daily, weekly, monthly or annual basis. The preset time could be altered manually at the controller, or remotely from a server.

Alternatively, the controller could be turned on purely on the basis of receiving a signal from the temperature sensors, whereby the controller switches on if a change of temperature, or a rise in temperature above a threshold, is detected. A timer may be provided, but the timer may also be overridden by a change in temperature above a threshold. If, for example, the closed space is a kitchen, then the controller will switch on and the temperature in the closed space will be controlled, if someone begins cooking outside of scheduled time.

The method may further comprise a cool down function, whereby when the controller is switched off the extractor fans will run at a minimum speed for a further 1-60 minutes to clear any residual heat. If after the cool down function has completed and the ambient temperature is above a pre-set threshold, then the cool down function will operate for a further time.

One or more controller could be connected in a network to a server, and information relating to power use and fan speeds and the like could be fed back to the server. Each kitchen within a network could have different atmospheric conditions, for example if they are in different parts of a country, and therefore have different ambient temperatures. Calculations regarding optimized settings compared to default settings could then be fed back to each controller from the server. Optimization of settings could be undertaken by Artificial Intelligence.

According to a further aspect of the present invention there is provided a ventilation demand control system for use in a closed space comprising:
one or more sensor consisting of a temperature sensor;
a controller comprising a processor;
at least one extractor fan;
at least one air intake;
wherein the processor controls the temperature and/or air pressure in the closed space by controlling the speed of the extractor fan, based on input from the or each sensor;
and the processor controls the rate of intake of air from the air intake, based on the speed of the or each extractor fan, as previously described.

The closed space may be a kitchen and may therefore comprise one or more cooking area comprising at least one cooking appliance, with an extractor hood comprising an extractor fan being disposed above each cooking area. The temperature sensor, if present, may be disposed in the extractor hood. Preferably the kitchen comprises three cooking appliances. Each cooking area is independent of the other and can be controlled separately so that, for example, each extractor fan runs at a different speed if the cooking appliances are operating at different temperatures. The present system may comprise three cooking appliances, each with a cooker hood disposed above each cooking appliance, the cooker hoods comprising an extractor fan and temperature sensor, and wherein each extractor fan is individually controllable based on feedback from the temperature sensor within each hood. Individual extractor fans could have different maximum and minimum speeds.

The controller may be disposed within a sealed housing. This will ensure that the contents of the housing are not damaged, tampered with or exposed to a harmful environment. The sealed housing may comprise a touchscreen. A touchscreen may be used to display diagnostic information relating to the controller and may be used to switch on and off the controller. If a fault is diagnosed, the control could operate all extractor fans and/or air intake to 100% capacity.

The controller may comprise wireless communication means to communicate with a further device. The further device could communicate diagnostic or status information to a remote user or could be used by a remote user to program and control the controller. The controller could be in communication with a remote server. The controller settings could be controlled from the server. A network of controllers could be linked to a server, for example a plurality of controllers within a plurality of separate closed spaces. Settings relating to operating times, temperatures, fan speeds, diagnostic information, power use and the like could be fed back to the server. For example, one or more of the controllers within the network could be switched on or off remotely via the server.

According to a further aspect of the present invention there is provided a non-transitory computer readable storage medium comprising instructions which, when executed by a computer, cause the computer to carry out the present method.

So that it may be better understood, the present invention will now be described in detail, but by way of example only, with reference to the following figures wherein:

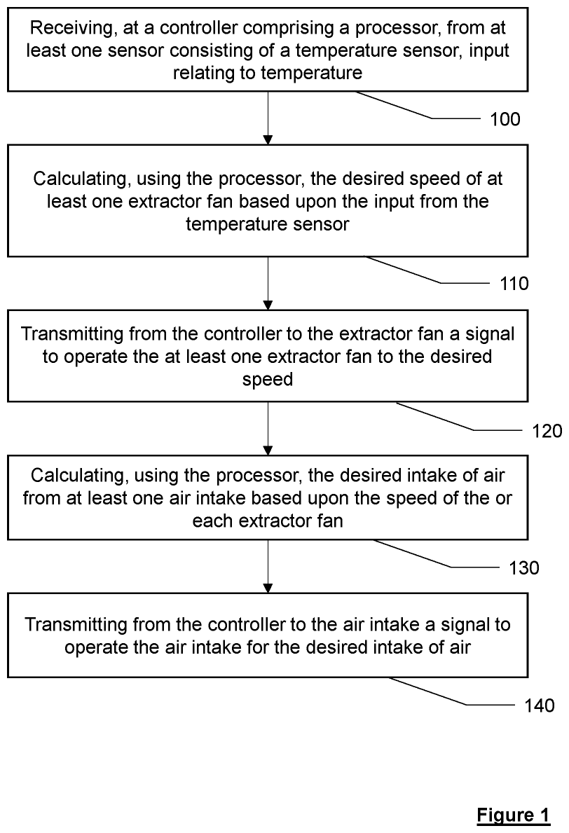

FIG. 1 shows a flow chart of the computer implemented method;

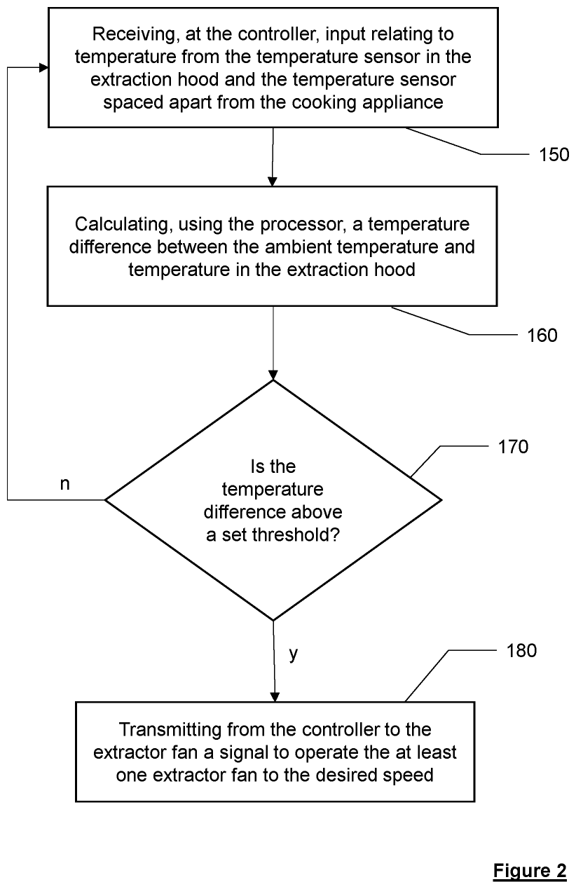

FIG. 2 shows a flow chart of further computer implemented method steps;

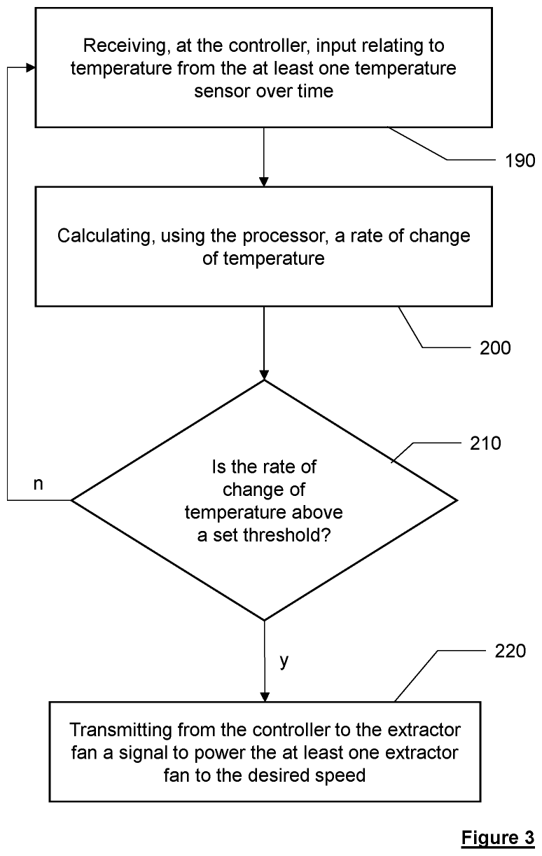

FIG. 3 shows a flow chart of further computer implemented method steps;

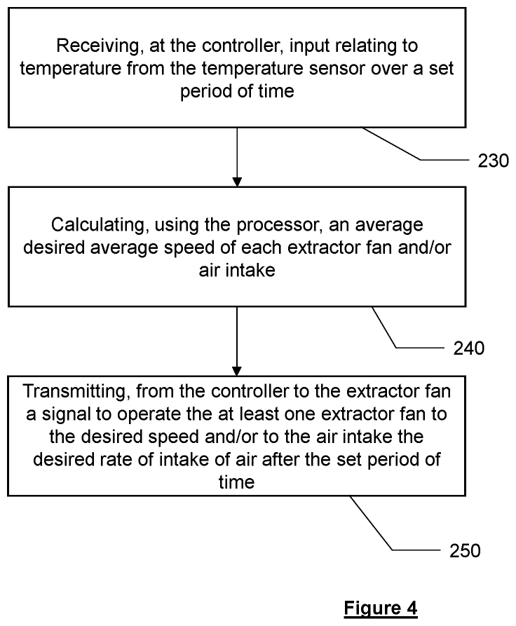

FIG. 4 shows a flow chart of further computer implemented method steps;

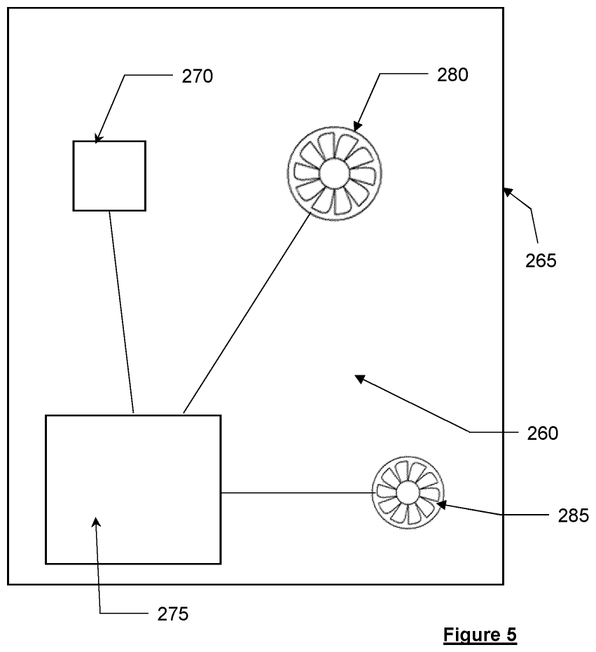

FIG. 5 shows a schematic diagram of a ventilation demand control system;

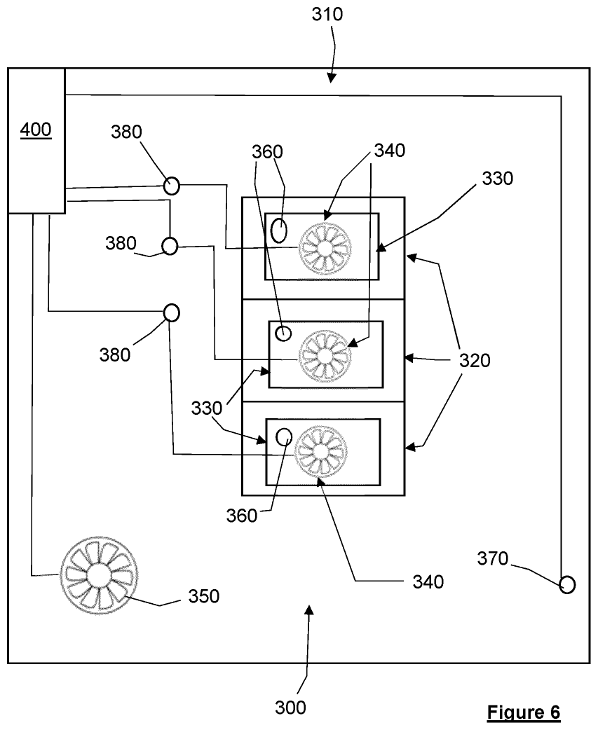

FIG. 6 shows a further schematic diagram of a ventilation demand control system;

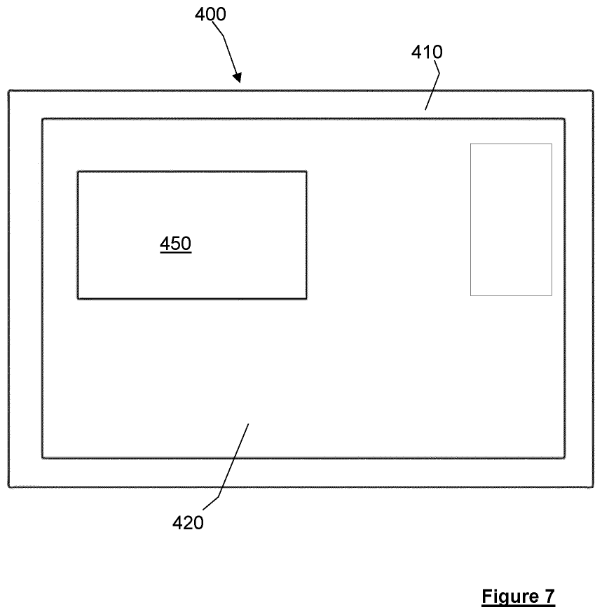

FIG. 7 shows a front panel of a controller;

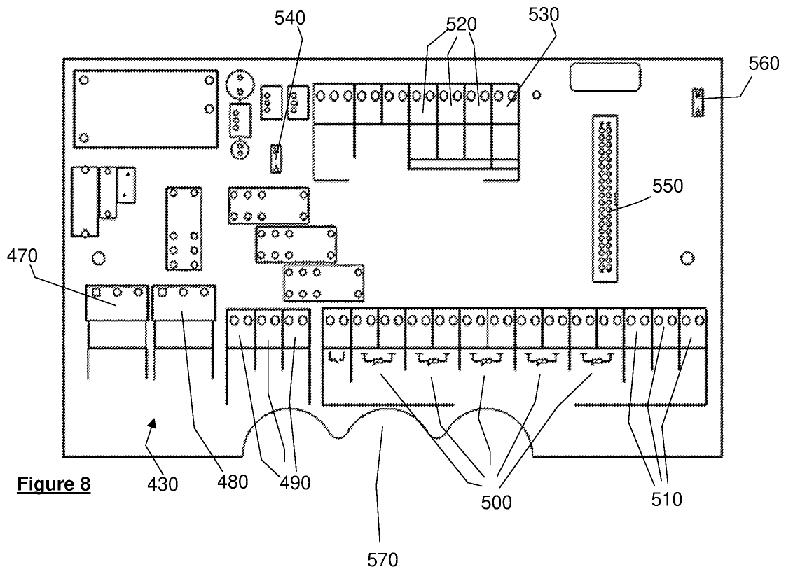

FIG. 8 shows a PCB of the controller of FIG. 7; and

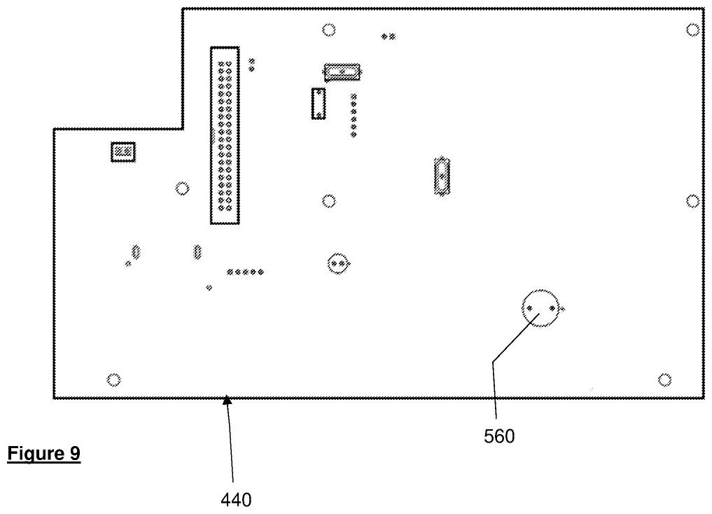

FIG. 9 shows a further PCB of the controller of FIG. 7.

Turning first to FIG. 1, there is shown a computer-implemented method of controlling ventilation in a closed space, the method comprising the following steps. At Step 100, receiving, at a controller comprising a processor, from at least one sensor consisting of a temperature sensor, input relating to temperature from the temperature sensor; at Step 110, calculating, using the processor, the desired speed of at least one extractor fan based upon the input from the temperature and/or current sensor; at Step 120 transmitting from the controller to the extractor fan a signal to operate the at least one extractor fan at the desired speed; at Step 130 calculating, using the processor, the desired intake of air from at least one air intake based upon the input from the extractor fans; and at Step 140 transmitting from the controller to the air intake a signal to operate the air intake for the desired intake of air. The rate of intake of air through the air intake is proportional to the rate of the at least one extraction fan. The air intake may be either an intake fan or a louvre comprising adjustable slats. If the air intake is an intake fan, the at least one intake fan speed is a set ratio of the speed of the at least one extractor fan, and the at least one intake fan speed is set at any speed within the range of 10-90% of the speed of the at least one extractor fan. If the air intake is a louvre, the angle of the adjustable slats will be adjusted to permit the desired intake of air.

The temperature sensor is located in the vicinity of an extraction hood above a cooking area comprising at least one cooking appliance for sensing the temperature as a result of the cooking appliance operating, and a further temperature sensor is located spaced apart from the cooking area so as to measure ambient temperature in the closed space. As shown in FIG. 2 the method further comprises the steps of: at Step 150 receiving, at the controller, input relating to temperature from the temperature sensor in the extraction hood and the temperature sensor spaced apart from the cooking area; at Step 160 calculating, using the processor, a temperature difference between the ambient temperature and temperature in the extraction hood, and, if, at Step 170, the temperature difference is above a set threshold, transmitting, at Step 180, from the controller to the extractor fan a signal to operate the at least one extractor fan at the desired speed.

As an alternative to, or in addition to, the method steps of FIG. 2, as shown in FIG. 3, the computer implemented method comprises the further steps of, at Step 190 receiving, at the controller, input relating to temperature from the temperature sensor over time; at Step 200 calculating, using the processor, a rate of change of temperature, and, at Step 210, if the rate of change of temperature is above a set threshold, transmitting, at Step 220, from the controller to the extractor fan a signal to power the at least one extractor fan to the desired speed.

As shown in FIG. 4, the computer implemented method comprises the further steps of, at Step 230 receiving at the controller, from the or each temperature sensor, input relating to temperature over a set period of time; at Step 240 calculating, at the processor, an average desired speed of each extractor fan and/or rate of air intake, over the set period of time; wherein the controller transmits, at Step 250, to the extractor fan the desired speed and/or desired rate of air intake after the set period of time. Where the air intake is a louvre comprising adjustable slats, a desired angle of horizontal slat corresponding to the desired intake of air is transmitted by the controller to the louvre. The slats may be adjustable between two or more pre-set positions.

As shown in FIG. 5, there is shown a schematic diagram of a ventilation demand control system, generally indicated 260, for use in a closed space generally indicated 265, comprising one or more sensor, generally indicated 270 consisting of a temperature sensor; a controller comprising a processor generally indicated 275, at least one extractor fan generally indicated 280, and an air intake, generally indicated 285, wherein the processor controls the temperature and/or air pressure in the closed space by controlling the speed of the extractor fan 280 and rate of intake of air through air intake 285, based on input from the or each sensor 270.

As show in FIG. 6 there is provided a further schematic diagram of a ventilation demand control system generally indicated 300, for implementing the present computer implemented method. There is shown a closed space generally indicated 310 which in the present example is a kitchen. Disposed within the closed space 310 are three cooking areas generally indicated 320. Each cooking area may comprise one or more cooking appliance. Disposed above each cooking area 320 are extractor hoods generally indicated 330 which each comprise an extractor fan generally indicated 340. The extractor fans 340 are arranged to extract air from the closed space 310 to control the temperature and air quality which may be adversely affected by use of the cooking appliances. The closed space 310 is further provided with an air intake, which in this example is an intake fan generally indicated 350. When air is extracted from the closed space 310, the intake fan 350 is operated to replace the air, which has the effect of lowering the air temperature, replenishing with clean air, and maintaining air pressure. Alternatively, the air intake may be a louvre with adjustable slats. The air intake 350 is operated to maintain a negative air pressure to, for example, retain cooking smells within the closed space 310.

The three cooking areas 320 are all independently operable, so that if each cooking appliance within each cooking area is operating at a different temperature, then the extractor fan 340 disposed in the extraction hood 330 above each cooking appliance will be operated at a different speed by the controller 380.

Within each extractor hood is a temperature sensor 360 and disposed on the wall spaced apart from the cooking area 320 is a further temperature sensor 370 which detects the ambient temperature within the closed space 310.

The controller 380, as will be described in more detail later, is disposed on a wall of the closed space 310 for controlling the ventilation within the closed space 310 based on the input from at least one temperature sensor.

FIG. 7 shows a front panel of a controller 400 for use in the present invention. The controller comprises a housing generally indicated 410 having a front panel 420 and containing PCB 430 and 440 described later with reference to FIGS. 8 and 9. Front panel 420 further comprises a touchscreen control 450 which can be used to switch on the controller, display diagnostic information, settings and the like and can be used to control the ventilation demand control system. In alternative embodiments, a manual power switch may be provided or the controller could be operated remotely via feedback from the sensors or from a server.

Turning now to FIG. 8 there is shown PCB 430 for controlling the ventilation demand control system of the present application, and to which the various components of the system are connected. There is shown power line in connector 470 where mains power is supplied to the controller 400, and fire alarm shunt 480 which will disable the ventilation demand control system, and all of the components such as the cooking appliances within cooking areas 320 in the event of a fire alarm activation. In the event of a fire alarm activation, the voltage is diverted through the fire alarm shunt to provide the required voltage to trip a shunt breaker isolating the cooking appliances. PCB 430 is further provided with hood light connections 490. The present controller can control three extractor fans which also comprise hood lights (not shown). The present PCB 430 further comprises five four-wire temperature sensor connectors 500 through which input is received from temperature sensors 360 disposed in ventilation hoods 330 in the closed space 310 and also from ambient temperature sensor 370, if provided.

PCB 430 further comprises three 0-10V fan output connectors 520 for transmitting a variable signal to the extractor fans 340, and a 0-10V fan output connector 530 for transmitting a variable signal to the intake fan 350 to control their respective speeds in use.

Further provided is a manual fan override switch 540 to be used as a fail-safe, and read/write Modbus connection 560 which, when paired with an external hub (not shown), allows the system to be monitored remotely and have settings changed where necessary. The remote operator can also boost the fan speeds or cancel the boost if it has been activated locally.

PCB 430 comprises three generally circular cut-away portions 570 to permit easy access to cabling when the PCB 430 is installed in the housing 410.

PCB 440, connected to PCB 430 via a wired connector at respective ports 550, comprises the touchscreen controls and the processor 560, comprising a memory, for undertaking the present computer implemented method.

The memory may store time schedules, so that the controller 400 switches on and off at certain times of the day, though this may be overridden manually or when a cooking appliance is switched on. A cooking appliance switching on may be detected by a detected rate of change of temperature as described with reference to FIG. 4, or a temperature difference with respect to ambient temperature as described with reference to FIG. 3.

The controller includes a boost and boost overrun function, which may be operated manually by pressing a “boost” button on the touchscreen (not shown). Pressing the boost button will switch all fans to maximum capacity (10V) irrespective of the maximum fan speeds configured upon installation. The boost will stay active until either the configured boost time elapses or the boost button is pressed again.

A fire alarm function may be operated when there is a fire alarm activation. As well as the cooking appliances being isolated, and switched off during a fire alarm activation, the fire panel function may operate in one of four different ways. Firstly, the extractor fans and air intake may be switched off. Secondly, the extractor fans and air intake could be operated at maximum (10V) capacity, thirdly the extractor fans could be switched to maximum (10V) capacity but the air intake be switched off, or fourthly the air intake could be switched to maximum (10V) capacity but the extractor fans be switched off.

1. A computer-implemented method of controlling ventilation in a closed space, the method comprising:
receiving, at a controller comprising a processor, from at least one sensor consisting of a temperature sensor, input relating to temperature;
calculating, using the processor, the desired speed of at least one extractor fan based upon the input from the at least one temperature sensor;
transmitting from the controller to the extractor fan a signal to operate the at least one extractor fan at the desired speed;
calculating, using the processor, the desired intake of air from at least one air intake based upon the speed of the at least one extractor fans; and
transmitting from the controller to the air intake a signal to operate the at least one air intake for the desired intake of air.

2. A computer implemented method as claimed in claim 1, wherein the rate of air intake is a set ratio of the speed of the at least one extractor fan.

3. A computer implemented method as claimed in claim 2, wherein the rate of air intake is set at 10-90% of the speed of the at least one extractor fan.

4. A computer implemented method as claimed in claim 1, wherein the air intake is at least one of an intake fan or an adjustable louvre.

5. A computer implemented method as claimed in claim 1, wherein the temperature sensor is located in the vicinity of an extraction hood disposed above at least one cooking appliance for sensing the temperature as a result of the at least one cooking appliance operating.

6. A computer implemented method as claimed in claim 5, wherein a further temperature sensor is located spaced apart from the at least one cooking appliance so as to measure ambient temperature in the closed space, the method further comprising the steps of receiving, at the controller, input relating to temperature from the temperature sensor in the extraction hood and the temperature sensor spaced apart from the at least one cooking appliance; and
calculating, using the processor, a temperature difference between the ambient temperature and temperature in the extraction hood, and, if the temperature difference is above a set threshold, transmitting from the controller to the extractor fan a signal to power the at least one extractor fan to the desired speed.

7. A computer implemented method as claimed in claim 1, comprising the further steps of:
receiving, at the controller, input relating to temperature from the at least one temperature sensor over time; and
calculating, using the processor, a rate of change of temperature, and, if the rate of change of temperature is above a set threshold, transmitting from the controller to the extractor fan a signal to power the at least one extractor fan to the desired speed.

8. A computer implemented method as claimed in claim 1, comprising the further steps of:
receiving at the controller, from the at least one temperature sensor, input relating to temperature over a set period of time;
calculating, at the processor, an average desired speed of each extractor fan and/or rate of air intake, over the set period of time;
wherein the controller transmits to the extractor fan the desired speed of extractor fan and/or to the air intake the desired rate of intake of air after the set period of time.

9. A computer implemented method as claimed in claim 1, comprising the following further steps:
transmitting to the air intake, wherein the air intake is a louvre comprising adjustable slats, a desired angle of slat corresponding to the desired intake of air.

10. A computer implemented invention as claimed in claim 9, wherein the slats are adjustable between two or more pre-set positions.

11. A ventilation demand control system for use in a closed space comprising:
one or more sensor consisting of a temperature sensor;
a controller comprising a processor;
at least one extractor fan;
at least one air intake;
wherein the processor controls the temperature and/or air pressure in the closed space by controlling the speed of the extractor fan, based on input from the or each sensor and the processor controls the rate of intake of air from the air intake based on the speed of the or each extractor fan.

12. The ventilation demand control system as claimed in claim 11, wherein the closed space comprises one or more cooking area comprising one or more cooking appliance, an extractor hood comprising an extractor fan disposed above each cooking area.

13. The ventilation demand control system as claimed in claim 12, wherein the temperature sensor is disposed in the extractor hood.

14. The ventilation demand control system as claimed in claim 11, wherein the controller is disposed within a sealed housing.

15. The ventilation demand control system as claimed in claim 14, wherein the sealed housing comprises a touchscreen.

16. A ventilation demand control system as claimed in claim 11, comprising three cooking appliances, each with a cooker hood disposed above each cooking appliance, the cooker hoods comprising an extractor fan and temperature sensor, and wherein each extractor fan is individually controllable by the controller.

17. A non-transitory computer readable storage medium comprising instructions which, when executed by a computer, cause the computer to carry out the method of claim 1.
